(19) United States
(12) Patent Application Publication
(10) Pub. No.: US 2007/0031563 A1
(43) Pub. Date: Feb. 8, 2007

(54) Cookies comprising emulsified liquid shortening compositions comprising dietary fiber gel, water and lipid

(75) Inventors: Triveni P. Shukla, New Berlin, WI (US); Gregory J. Halpern, Vernon Hills, WI (US)

Correspondence Address: Z Trim Holdings, Inc., 1011 Campus Drive, Mundelein, IL, 60060, US

(73) Assignee: Z Trim Holdings, Inc.

(21) Appl. No.: 11/545,699

(22) Filed: Oct. 10, 2006

Related U.S. Application Data
(63) Continuation-in-part of application No. 10/689,194, filed on Oct. 20, 2003, now abandoned.

(51) Int. Cl. A21D 10/00

(52) U.S. Cl. 426/549

(57) ABSTRACT

According to the present invention, fat and caloric content of cookies can be reduced by the replacement of a portion fat content normally found in cookies with an amount of emulsified liquid shortening composition comprising dietary fiber gel, water and lipid. The result is that fat and caloric content of cookies can be manipulated with minimal effect on taste and texture. Furthermore, these emulsified mixtures, or “emulsified liquid shortening compositions comprising dietary fiber gel, water and lipid”, can further comprise functional foods such as high omega three and omega six oils and pure omega three and omega six fatty acids, medium chain triglyceride, beta carotene, calcium estearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources, and any combination thereof. Hence, in addition to reducing fat and caloric content of cookies, further health benefits can be achieved by replacing a portion of fat with emulsified liquid shortening compositions comprising dietary fiber gel, water and lipid.

### CROSS-REFERENCE TO RELATED APPLICATIONS

This application is a Continuation-in-Part Application of U.S. patent application Ser. No. 10/689,194 filed on Oct. 20, 2003, the entirety of which is incorporated herein by reference.

### STATEMENT REGARDING FEDERALLY SPONSORED RESEARCH/DEVELOPMENT

The present invention does not involve any form of federally sponsored research or development.

### BACKGROUND OF THE INVENTION

The present invention relates to cookies comprising emulsified liquid shortening compositions comprising dietary fiber gel, water and lipid. Recent media attention to the global problem of obesity demonstrates a need for greater availability of foods with low caloric and fat content. This is especially true for foods that typically have high fat and caloric content, such as cookies.

Cookies typically comprise some combination of flour, butter or margarine, and sugar. Other ingredients can vary according to the type of cookie and the recipe followed, but typically, cookies are high in both fat and caloric content.

In recent years, some companies have begun to offer reduced fat cookies. This variety of cookie, however, often involves increased sugar concentrations in order to compensate for the less desirable taste resulting from lower fat concentrations and frequently fails to retain the desirable taste and texture of cookies comprising higher fat contents.

The absence of a means to reduce the fat and caloric content of cookies while still producing a desirably flavored and textured cookie presents an unmet need in today's food industry.

### BRIEF SUMMARY OF THE INVENTION

It is an object of the present invention to provide a unique composition of matter embodied by low-calorie and low-fat cookies. This reduction in caloric and fat content answers an unmet need within the food industry to provide the consuming public with a healthier, higher fiber alternative to traditional types of cookies that typically are inherently fattening. It is another object of the present invention to provide cookies that have been fortified with insoluble fiber and other functional foods.

Dietary fiber gels for calorie reduced foods hold the key to meeting this need. Dietary fiber gels for calorie reduced foods are fully described in U.S. Pat. No. 5,766,662 (the '662 patent). These dietary fiber gels comprise insoluble dietary fibers consisting of morphologically disintegrated cellular structures, and are characterized by their ability to retain large amounts of water. The dietary fiber gels are produced by shearing agricultural by-products, such as seed brans, hulls, and so forth, under alkaline conditions. Dietary fiber gels in a hydrated form can exist as a gel, and in the dehydrated form as flakes and powders. Additionally, these dietary fiber gels are characterized by their high viscosity at low solid levels. Other insoluble fibers derived from cereals, grains and legumes consist of morphologically intact cellular structures, and thus impart a gritty texture to the foods in which they are contained. The dietary fiber gels disclosed in the '662 patent, however, consist of morphologically disintegrated cellular structures and thus impart a smoother texture than other insoluble fiber formulations. A physically smooth morphology is readily revealed under electron microscopic magnification of amorphous insoluble cellulosic gel. The smooth morphology is also demonstrated by approximately 60 percent to 90 percent reduction in birefringence when compared to microcrystalline dietary fiber products. The smooth morphology reflects the amorphous nature of the insoluble compounds that constitute amorphous insoluble cellulosic fiber gel.

According to the present invention, fat and caloric content can be reduced by the replacement of the fat normally found in cookies with emulsified liquid shortening compositions comprising dietary fiber gel, water and lipid. This replacement of fat does not adversely affect either the taste or texture of the cookies. The result is that fat and caloric content of cookies can be manipulated with minimal effect on taste and texture, and as stated above, additional health benefits can be achieved through consumption of cookies comprising emulsified liquid shortening compositions comprising dietary fiber gel, water and lipid when functional foods are included in the formulations.

Further objects, advantages and features of the present invention will present themselves in the following detailed description.

### DETAILED DESCRIPTION OF THE PREFERRED EMBODIMENT

This invention is directed to cookies comprising emulsified liquid shortening compositions comprising dietary fiber gel, water and lipid. According to the present invention, fat and caloric content can be reduced by the replacement of fat normally found in cookies with emulsified liquid shortening compositions comprising dietary fiber gel, water and lipid (hereinafter “emulsified liquid shortening”). This replacement of fat does not adversely affect either the taste or texture of the cookies. The result is that fat and caloric content of cookies can be manipulated with minimal effect on taste and texture.

More specifically, the present invention utilizes emulsified mixtures of the dietary fiber gels disclosed in the '662 patent, the emulsified mixtures further comprising, at a minimum, water and lipid. The dietary fiber gel as disclosed in the '662 patent can be as-produced and reconstituted. The as-produced dietary fiber comes from the shearing of agricultural by-products under alkaline conditions. For example, under alkaline conditions oat hulls can be extruded and then sheared in a Waring blender to produce such a gel. When the as-produced dietary fiber gel is dried, a reconstituted dietary fiber gel can be made by subjecting the dried product to water. For example, as-produced dietary fiber gel can be oven, freeze, and spray dried and then reconstituted by vigorous stirring and blending in a Waring™ blender to produce a reconstituted dietary fiber gel that is essentially identical to the corresponding as-produced dietary fiber gel.

These emulsified mixtures are fully described in and are the subject of U.S. patent application Ser. No. 10/669,731 filed Sep. 24, 2003, which is incorporated by reference in its entirety herein. The ingredients of emulsified mixtures include dietary fiber gel, water, and lipid. The lipid can be any oleic fatty acids, flax seed oil, olive oil, canola oil, corn oil, walnut oil, peanut oil, and any other vegetable oil, and any combination of these oils. The ingredient quantities on a total weight basis of 100 parts are preferably a range of 30 to 80 parts water, 0.3 to 20 parts dietary fiber gel solids, and a balance of lipid and other optional components. The ingredients are combined and mixed, and the mixture is subjected to high shear micro-particulation such as by homogenization, colloid milling, ultrasonication treatment, and so forth. For example, dietary fiber gel, water, and lipid can be combined, mixed, and then homogenized at a pressure of between 1500 to 2500 pounds per square inch and temperatures in the range of 120 to 195 degrees Fahrenheit.

These emulsified mixtures, or “emulsified liquid shortening compositions comprising dietary fiber gel, water and lipid”, can further comprise functional foods such as high omega three and omega six oils and pure omega three and omega six fatty acids, medium chain triglyceride, beta carotene, calcium estearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources, and any combination thereof. Hence, in addition to reducing fat and caloric content of cookies, further health benefits can be achieved by replacing a portion of fat with emulsified liquid shortening compositions comprising dietary fiber gel, water and lipid. Alternatively, the cookies can be provided in the form of cookie dough with the intention that a consumer can bake them at a convenient, post-purchase time, and cookie dough is considered to be within the scope of this invention. As such, for purposes of this document, the term “cookies” is defined to include cookie dough.

According to the present invention, cookies can be formulated such that the cookies comprise 0.25 percent to 7.0 percent dietary fiber gel solids by replacing an appropriate amount, that is, prorated to deliver this range of dietary fiber gel solids, of fat, including oil and liquid shortening, with an essentially identical amount of emulsified liquid shortening. The result is that fat and caloric content of cookies can be manipulated with minimal effect on taste and texture, and as stated above, additional health benefits can be achieved through consumption of cookies comprising emulsified liquid shortening compositions comprising dietary fiber gel, water and lipid when functional foods are included in the formulations.

### EXAMPLES

BASIC EMULSION (Emulsified Liquid Shortening)

| Ingredients | Percent | Preparation/Remarks |
|---|---|---|
| Water | 88.50 | 1. Blend at highest possible |
| | | speed Ztrim powder in |
| | | water to produce a creamy gel |
| Dietary Fiber Gel Powder | 4.00 | |
| High Omega Canola Oil | 7.50 | 2. Add oil or oily pastes |
| | | (almond, sesame seed) and |
| | | blend well at low speed |
| Flavor and color as | | |
| desired specific to | | |
| a product type | | |

### Example 1

### Cookie

| | | W/ | |
|---|---|---|---|
| Ingredients | CONTROL | EMULSION | Preparation/Remarks |
| Sugar | 11.45 | | 1. Combine and |
| | | | cream all liquids |
| Brown Sugar | 11.45 | | 2. Add eggs and cream |
| | | | at slow mixing |
| Butter | 7.63 | 4.00 | 3. Add flour and knead |
| | | | dough lightly |
| Salt | 0.24 | | 4. Add pecan and |
| | | | mix well |
| Sodium Carbonate | 0.53 | | |
| Egg, Whole | 11.45 | 7.00 | 5. Bake at 350 Deg f. |
| | | | for 12-15 minutes |
| Basic Emulsion | | 8.08 | |
| Pastry Flour | 22.90 | | |
| Chocolate Chip | 30.53 | | |
| Pecan | 3.82 | | |
| | 100.00 | | |

### Example 2

### Chocolate Chip Cookie

| | | W/ | |
|---|---|---|---|
| Ingredients | CONTROL | EMULSION | Preparation/Remarks |
| Sugar | 400.00 | 400.00 | 1. Grind oatmeal into |
| | | | powder in a blender |
| Brown Sugar | 400.00 | 400.00 | 2. Cream butter and |
| | | | both sugars. |
| Butter | 400.00 | 200.00 | 3. Add eggs and |
| | | | Vanilla. |
| Salt | 10.00 | 10.00 | 4. Mix together flour, |
| | | | oat meal, salt, |
| | | | baking soda |
| | | | and powder. |
| Sodium Bicarbonate | 10.00 | 10.00 | 5. Add cocolate chips, |
| | | | Hershey bar and |
| | | | walnut. |
| Baking Powder | 10.00 | 10.00 | 6. Roll into balls and |
| | | | place on cookie |
| | | | sheet two |
| | | | inches apart |
| Egg, Whole | 250.00 | 175 | 7. Bake at 375 for ten |
| | | | minutes |
| Chocolate Chip | 675.00 | 675.00 | 112 cookies/Batch |
| Grated walnut | 300.00 | 300.00 | (Appx 1 Oz Cookie) |
| Flour | 440.00 | 440.00 | |
| Oatmeal | 350.00 | 350.00 | |
| Grated Chocolate | 500.00 | 500.00 | |
| Basic Emulsion | | 275.00 | |
| | 3745.00 | 3745.00 | |

I claim:

1. Cookies, the cookies having a formulation, the cookies comprising emulsified liquid shortening composition comprising dietary fiber gel, water and lipid,
wherein the emulsified liquid shortening composition comprising dietary fiber gel, water and lipid is added in a prorated amount such that solids delivered by the dietary fiber gel represent 0.25 percent to 7.0 percent by weight of the overall cookie formulation, and
the emulsified liquid shortening composition comprising dietary fiber gel, water and lipid replaces an amount of fat used in an otherwise identical recipe of cookie that uses no emulsified liquid shortening compositions comprising dietary fiber gel, water and lipid.

2. Cookie dough, the cookie dough having a formulation, the cookie dough comprising emulsified liquid shortening composition comprising dietary fiber gel, water and lipid,
wherein the emulsified liquid shortening composition comprising dietary fiber gel, water and lipid is added in a prorated amount such that solids contained within the dietary fiber gel represent 0.25 percent to 7.0 percent by weight of the overall cookie dough formulation, and
the emulsified liquid shortening composition comprising dietary fiber gel, water and lipid replaces an amount of fat used in an otherwise identical recipe of cookie dough that uses no emulsified liquid shortening compositions comprising dietary fiber gel, water and lipid.
